(19) United States
(12) Patent Application Publication
(10) Pub. No.: US 2007/0149152 A1
(43) Pub. Date: Jun. 28, 2007

(54) Wireless Transmitters with Temperature Gain Compensation

(76) Inventors: Bao-Shan Hsiao, Ping-Tung Hsien (TW); John-San Yang, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/616,025

(22) Filed: Dec. 26, 2006

(30) Foreign Application Priority Data
Dec. 28, 2005 (TW) 094147020

(51) Int. Cl. H01Q 11/12; H04B 1/04

(52) U.S. Cl. 455/127.2

(57) ABSTRACT

A wireless transmitter with temperature gain compensation includes a temperature sensor, a mixer, a power amplifier, a matching circuit, and an antenna. The mixer includes a mixer circuit and a gain compensation circuit. The gain compensation circuit includes a plurality of compensation units in parallel. Each compensation unit includes a resistor and a switch for turning on or off the switch to adjust the mixer's gain according to the sensed temperature of the temperature sensor. The wireless transmitter further includes a voltage gain control amplifier for choosing the output power of the transmitter.

### BACKGROUND OF THE INVENTION

1. Field of the Invention

The present invention provides a transmitter with gain compensation, particularly a transmitter with temperature gain compensation.

2. Description of the Prior Art

In the modern world of information, the need for mobility increases day by day. Therefore the usage of wireless networks is getting widely spread, and more electronic communication products are used for wirelessly transmitting and receiving data. Due to the fact of wireless transmission, the maintenance of a good signal quality is significant. Thus, keeping a consistent output power of the transmitter becomes an important part of wireless communication.

Please refer to FIG. 1. FIG. 1 is a transmitter 10 diagram of the prior art. The transmitter 10 includes a mixer 11, a voltage gain control amplifier 12, a power amplifier 13, a matching circuit 14 and an antenna 15. The mixer 11 is used to mix a baseband signal 19 with a local oscillator 18 to produce a mixing signal for voltage gain control amplifier 12. The voltage gain control amplifier 12 is coupled between the mixer 11 and the power amplifier 13 to select a reference output power of transmitter 10. The power amplifier 13 is coupled to the voltage gain control amplifier 12 for increasing the mixing signal power after the voltage gain control amplifier 12 selects the reference output power. The matching circuit is coupled between the power amplifier 12 and the antenna 15 for impedance matching in order to lower power loss. Finally the wireless signal is transmitted through the antenna 15.

Please refer to FIG. 2. FIG. 2 is a graph showing the relationship between the gain of a wireless electronic signal in high frequencies and temperature. In the graph, the horizontal axis represents the frequencies while the vertical axis represents the gain. The lowest curve in the graph represents the relations between gain and frequencies at 70 degrees Celsius whereas the middle and the upmost curves represent the relations between gain and frequencies at 27 degrees Celsius and −30 degrees Celsius, respectively. According to FIG. 2, it is known that when temperature changes, the primary characteristics of the transmitter itself change. As the output power increases, the output noise increases correspondingly. Therefore maintaining a consistent output power of the transmitter is necessary.

Please refer to FIG. 3. FIG. 3 represents the compensation method of the prior art transmitter 30. The transmitter 30 comprises a mixer 31, a voltage gain control amplifier 32, a power amplifier 33, a matching circuit 34, an antenna 35, a baseband IC 36 and a power sensor 37. Within these, the mixer 31, the voltage gain control amplifier 32, the power amplifier 33, the matching circuit 34, and the antenna 35 are identical to those in FIG. 1. The power sensor 37 is coupled between the power amplifier 33 and the matching circuit 34 to detect the power of the mixing signal after being amplified by the power amplifier 33 and to convert the detected signal amplitude to a voltage V_{PD}. The baseband IC 36 is coupled between the power sensor 37 and the voltage gain control amplifier 32 to output a voltage V_{VGA} to voltage gain control amplifier 32. The baseband IC 36 comprises the power sensing curve corresponding to the different voltages of V_{PD} obtained from off-factory tests and according to the power sensing curve outputs the voltage V_{VGA} in order to control the voltage gain control amplifier 32 maintaining a consistent output power.

The transmitters with this type of gain compensation method have the following disadvantages: inconvenience in usage, as every IC requires measured power sensing characteristics to be the gain compensation reference of the baseband IC 36; and uncertainty of accuracy, as the power sensor 37 virtually detects the amplitude of the power amplifier 33, so when the output impedance or the impedance of the matching circuit 34 changes, the detected amplitude changes accordingly. Thus, the uncertainty of accuracy increases.

From the above, even though the gain compensation method of the prior art transmitters is able to control the gain amplifier 32 through the controlled voltage of baseband IC 36 and rectify the output power, the baseband IC 36 is limited by its power sensing characteristic curve and the lack of accuracy which leads to the gain still changing with temperature and the baseband IC 36 being unable to maintain a consistent output power.

### SUMMARY OF THE INVENTION

The invention provides a transmitter with temperature gain compensation comprising a temperature sensor; a mixer comprising a mixing circuit for producing a mixing signal of a baseband signal and a local oscillation signal, and a gain compensation circuit coupled between the mixing circuit and the temperature sensor for compensating a gain of the mixer, the gain compensation circuit including a plurality of compensation units coupled in parallel which are driven on and off by a detected temperature sensed by the temperature sensor; a power amplifier coupled to the mixer; an antenna couple to the power amplifier; and a matching circuit coupled between the power amplifier and the antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the transmitter of the prior art.

FIG. 2 is a graph showing the relationship between the gain of a wireless electronic signal in high frequencies and temperature.

FIG. 3 represents the compensation method of the prior art transmitter.

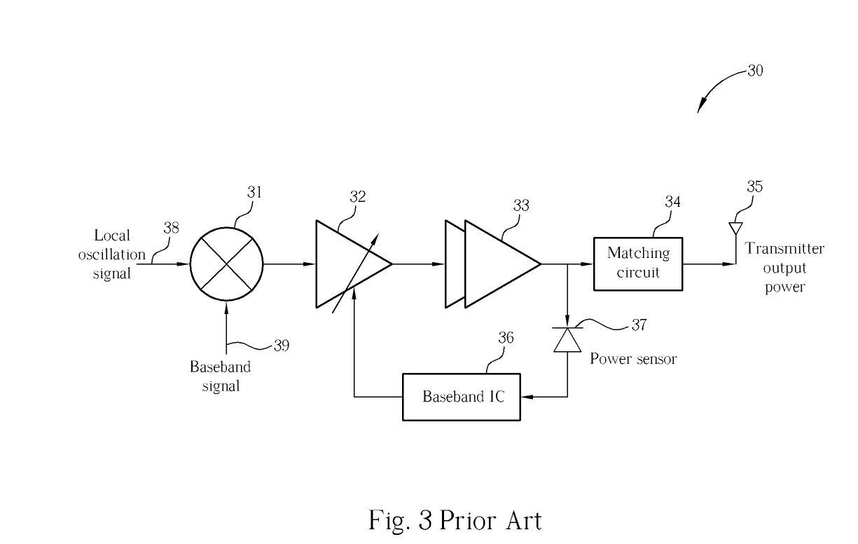

FIG. 4 is a diagram of a temperature sensor.

FIG. 5 is a table of temperatures set by the temperature sensor in FIG. 4 and corresponding digital bits.

FIG. 6 is a diagram of a transmitter with temperature gain compensation of the present invention.

FIG. 7 is a diagram of the mixer in FIG. 6.

FIG. 8 is a relationship diagram of high frequency gains corresponding to changes in temperature of the transmitter in FIG. 6.

FIG. 9 is a diagram of another transmitter with temperature gain compensation.

FIG. 10 is a diagram of the input buffer shown in FIG. 9.

FIG. 11 is another diagram of the input buffer shown in FIG. 9.

### DETAILED DESCRIPTION

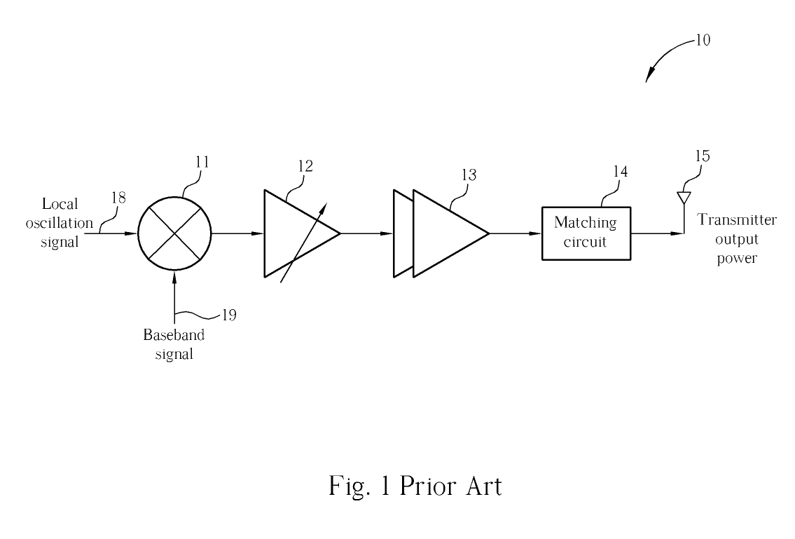

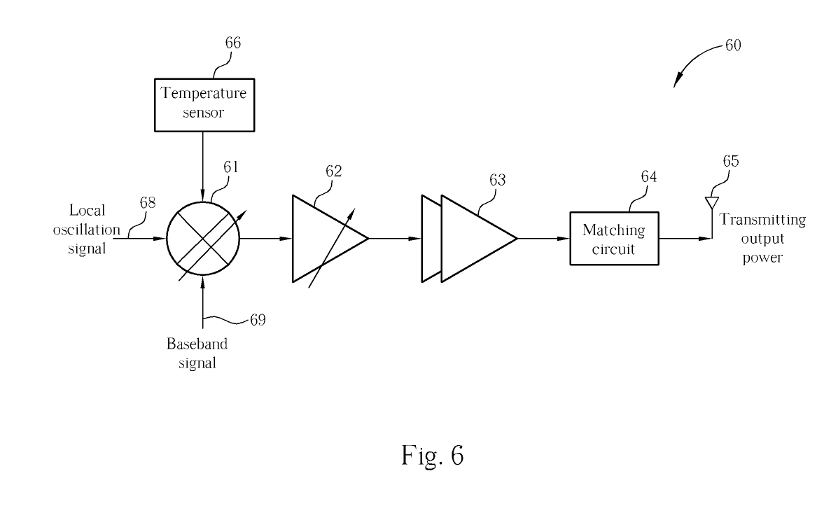

Please refer to FIG. 6. FIG. 6 is a diagram of a transmitter 60 with temperature gain compensation of the present invention. The transmitter 60 comprises a mixer 61, a voltage gain control amplifier 62, a power amplifier 63, a matching circuit 64, an antenna 65 and a temperature sensor 66. The voltage gain control amplifier 62, the power amplifier 63, the matching circuit 64, the antenna 65 and the voltage gain control amplifier 12, the power amplifier 13, the matching circuit 14, the antenna 15 of FIG. 1 are identical. The temperature sensor 66 is coupled to the mixer 61.

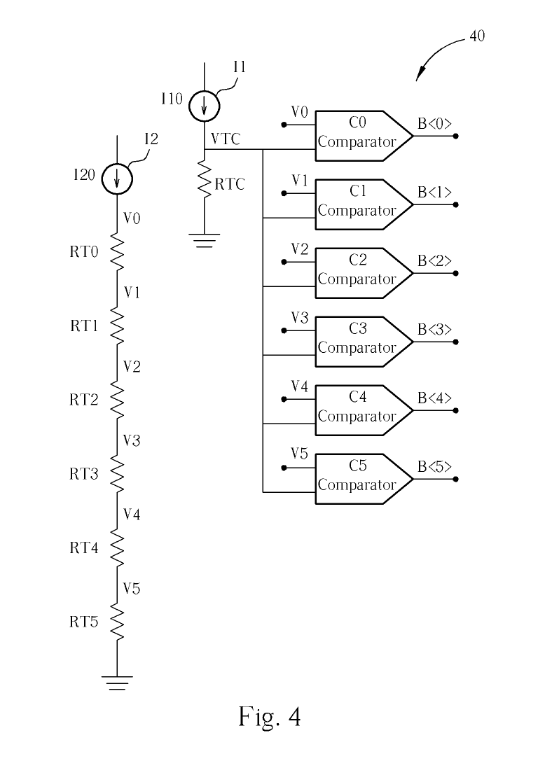

The temperature sensor 66 is not limited to a specific circuit. For instance, it can be implemented as demonstrated in FIG. 4. Please refer to FIG. 4. FIG. 4 is a diagram of a temperature sensor 40. The temperature sensor 40 comprises a first current source I1, a second current source I2, a temperature sensitive resistor RTC, six temperature control resistors RT0-RT5 and six comparators C0-C5. The first current source I1 and the second current source 12 are both reference currents, have the characteristic of being proportional to absolute temperature (PTAT), and are able to convert temperature variations into voltages. As the temperature rises, voltage rises. The first current source I1 provides an I10 amps current, and is coupled to the temperature sensitive resistor RTC. The voltage across the temperature sensitive resistor RTC, VTC, is the product of current I10 and resistance RTC; this is fed into first ports of each comparator CO-C5. The second current source I2 provides an I20 amps current, and is serially coupled to the six temperature control resistors RT0-RT5. The voltage across the temperature sensitive resistor RT5, V5, is the product of current I20 and resistance RT5; this is fed into a second port of the comparator C5. The voltage across the temperature sensitive resistor RT4, V4, is the product of current I20 and resistance (RT4+RT5); this is fed into a second port of the comparator C4. With the same idea, voltages V3, V2, V1, V0 are fed into second ports of the comparators C3, C2, C1, C0 respectively. VTC is compared with each of V0-V5, if VTC is smaller than V5, a zero (0) is output to bit B5; if VTC is larger than V5, then a one (1) is output to bit B5. With the same idea, if voltage VTC is smaller than voltages V4-V0, then a zero is output to bits B4-B0; if not, a one is output to bits B4-B0.

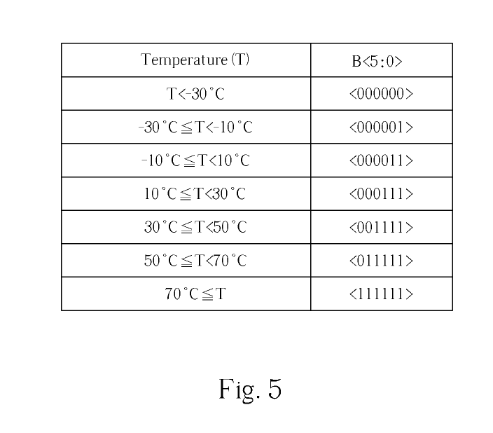

Please refer to FIG. 5. FIG. 5 is a table of temperatures set by the temperature sensor 40 in FIG. 4 and corresponding digital bits. As shown in FIG. 5, as a temperature T is smaller than negative 30 degrees, bits B0-B5 output is <000000>; as the temperature T is smaller than negative 10 degrees and larger than negative 30 degrees, bits B0-B5 output is <000001>; as the temperature T is smaller than 10 degrees and larger than negative 10 degrees, bits B0-B5 output is <000011>; as the temperature T is smaller than 30 degrees and larger than 10 degrees, bits B0-B5 output is <000111>; as the temperature T is smaller than 50 degrees and larger than 30 degrees, bits B0-B5 output is <001111>; as the temperature T is smaller than 70 degrees and larger than 50 degrees, bits B0-B5 output is <011111>; and as the temperature T is larger than 0 degrees, bits B0-B5 output is <111111>. The temperature control resistors RT0-RT5 and the temperature sensitive resistor RTC send different voltage inputs to the comparators C0-C5 according to temperature variation; therefore converting temperature to digital control and furthermore switching a gain of temperature compensation circuits on the inside achieves auto-compensation with temperature variation.

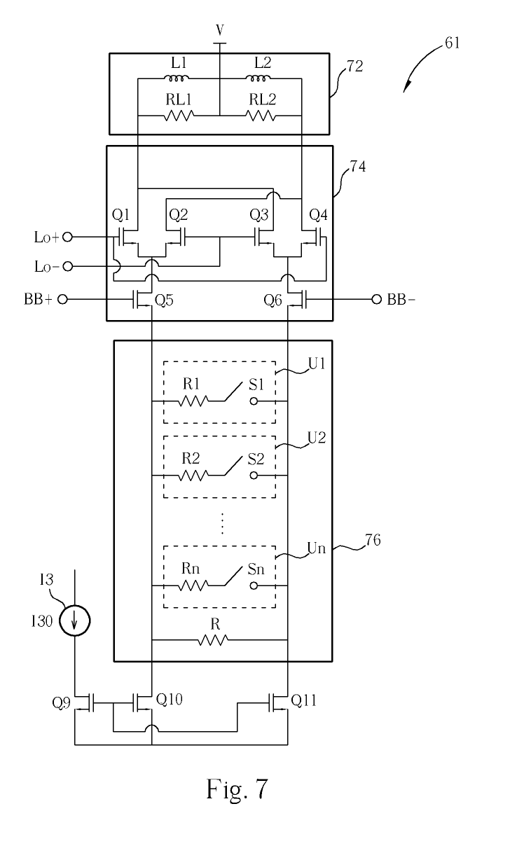

Please refer to FIG. 7 and FIG. 6. FIG. 7 is a diagram of the mixer 61 in FIG. 6. The mixer 61 comprises a mixing circuit 74 used for mixing a baseband signal BB+, BB− (the baseband signal 69 in FIG. 6) and a local oscillation signal Lo+, Lo− (the local oscillation signal 68 in FIG. 6) to generate a mixing signal, a load circuit 72 coupled to the mixing circuit 74, and a gain compensation circuit 76 coupled to the mixing circuit 74 and a temperature sensor 66 (not shown in FIG. 7) used for compensating a gain of the mixer. The mixing circuit 74 comprises a first transistor Q1 , a gate of the first transistor Q1 coupled to the local oscillation signal Lo+; a second transistor Q2, a gate of the second transistor Q2 coupled to the local oscillation signal Lo−; a third transistor Q3, a gate of the third transistor Q3 coupled to the local oscillation signal Lo− and the gate of the second transistor Q2; a fourth transistor Q4, a gate of the fourth transistor Q4 coupled to the local oscillation signal Lo+ and the drain of the third transistor Q3; a fifth transistor Q5, a gate of the fifth transistor Q5 coupled to the baseband signal BB+, and a source of the fifth transistor Q5 coupled to the drain of the first transistor Q1 and the drain of the second transistor Q2; and a sixth transistor Q6, a gate of the sixth transistor Q5 coupled to the baseband signal BB−, and a source of the sixth transistor Q6 coupled to the drain of the third transistor Q3 and the drain of the fourth transistor Q4. The first transistor Q1, the second transistor Q2, the third transistor Q3, the fourth transistor Q4, the fifth transistor Q5 and the sixth transistor Q6 are metal-oxide semiconductor (MOS) transistors.

Please refer to FIG. 7. A load circuit 72 comprises resistors RL1, RL2, and inductors L1, L2. The mixer 61 has an operation voltage, which is a supply voltage V. A first end of the resistor RL1 is coupled to a first end of the inductor L1, and is also coupled to the source of the first transistor Q1 and the source of the third transistor Q3. A second end of the resistor RL1 is coupled to a second end of the inductor L1 and the supply voltage V. A first end of the resistor RL2 is coupled to a first end of the inductor L2 and the supply voltage V. A second end of the resistor RL2 is coupled to a second end of the inductor L2 and is also coupled to the source of the second transistor Q2 and the source of the fourth transistor Q4.

Please refer to FIG. 7. The mixer 61 further comprises a third current source I3 used to provide a current I30 and three transistors Q9-Q11 used to provide current I30 with a current path. A source of the transistor Q9 is coupled to an output of the third current source I3; a gate of the transistor Q9 is coupled to a gate of the transistor Q10 and the gate of the transistor Q11; a drain of the transistor Q9 is coupled to a drain of the transistor Q10 and the drain of the transistor Q11. The source of the transistor Q10 is couple to a first end of the gain compensation circuit 76 and the drain of the fifth transistor Q5; the source of the transistor Q11 is couple to a second end of the gain compensation circuit 76 and the drain of the sixth transistor Q6.

Please refer to FIG. 7. The gain compensation circuit 76 comprises a plurality of compensation units U1-Un in parallel, each compensation unit comprising a resistor and a switch represented by R1-Rn and S1-Sn respectively. First ends of the resistors R1-Rn are coupled in parallel and also coupled to the first end of the gain compensation circuit 76. Second ends of the switches S1-Sn are coupled in parallel and also coupled to the second end of the gain compensation circuit 76. The gain compensation circuit 76 further comprises a resistor R coupled in parallel with the plurality of compensation units U1-Un, so that a resistance of the gain compensation circuit 76 is not 0. The resistor R can also be an adjustable resistor used for choosing a reference output power of the transmitter 60, and in this case the voltage gain control amplifier 62 is undesirable in choosing the reference output power of the transmitter 60. According to a temperature sensed by the temperature sensor 66, an equivalent resistance of the gain compensation circuit 76 can be changed with switching the plurality of switches S1-Sn. Due to a gain of the mixer 61 being proportional to a ratio of resistance of the load circuit 72 and resistance of the gain compensation circuit 76 (Gain≈Z/R), by choosing the equivalent resistance of the gain compensation circuit 76 to change the gain, the gain of the mixer 61 can be adjusted and compensated.

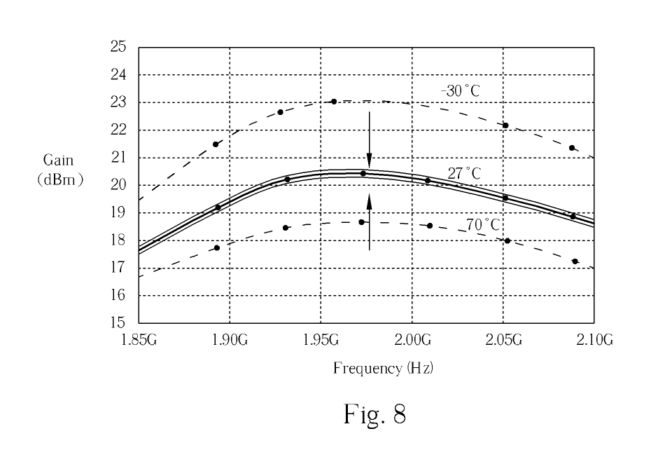

Please refer to FIG. 8 and FIG. 6. FIG. 8 is a relationship diagram of high frequency gains corresponding to changes in temperature of the transmitter 60 in FIG. 6. In FIG. 8, the horizontal axis represents frequency and the vertical axis represents gain. The lower and the upper curves represent 70 degrees Celsius and negative 30 degrees Celsius respectively (without the transmitter going through the auto gain compensation) the relationship between gain and frequency; the middle curve represents the relationship between gain and frequency at 27 degrees Celsius. As the transmitter 60 opens or closes the plurality of switches S1-Sn according to the temperature sensed by the temperature sensor 66, the equivalent resistance of the gain compensation circuit 76 is changed. By choosing the equivalent resistance of the gain compensation circuit 76, the gain can be changed and hence a constant output power can be maintained. As shown in FIG. 8, the lower and upper curves move with the directions of the arrows, meaning as temperature changes the gain of wireless signal output from the transmitter does not change and the output power of the transmitter remains constant.

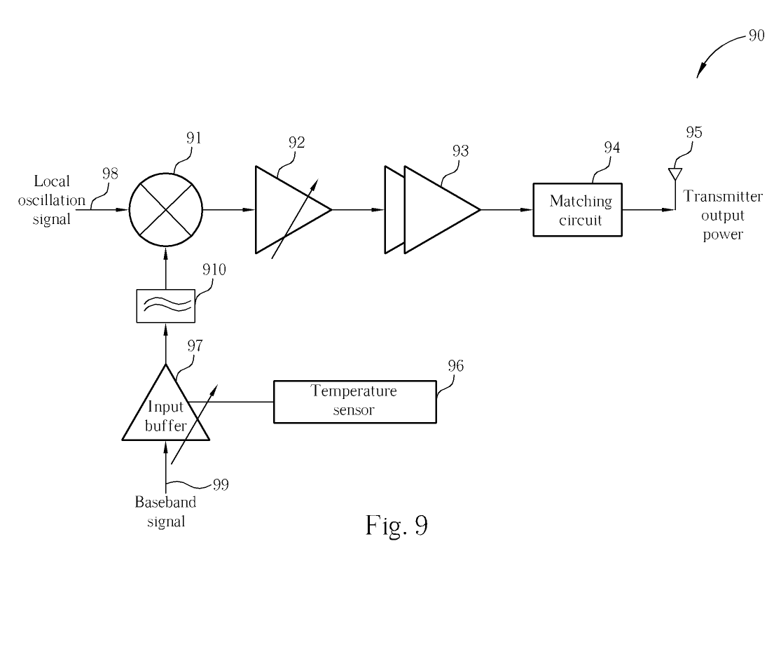

Please refer to FIG. 9. FIG. 9 is a diagram of another transmitter 90 with temperature gain compensation. The transmitter 90 comprises a mixer 91, a voltage gain control amplifier 92, a power amplifier 93, a matching circuit 94, an antenna 95, a temperature sensor 96, a band-pass filter 910 and an input buffer 97. The mixer 91, the voltage gain control amplifier 92, the power amplifier 93, the matching circuit 94 and the antenna 95 are the same as the mixer 11, the voltage gain control amplifier 12, the power amplifier 13, the matching circuit 14 and the antenna 15 in FIG. 1. And the band-pass filter 910 is used to filter noise, meaning to filter a baseband signal that had been adjusted by the input buffer 97 and then send an output signal to the mixer 91 to have it mixed with a local oscillation signal. The temperature sensor 96 can be the temperature sensor 40 in FIG. 4, and is coupled to the input buffer 97.

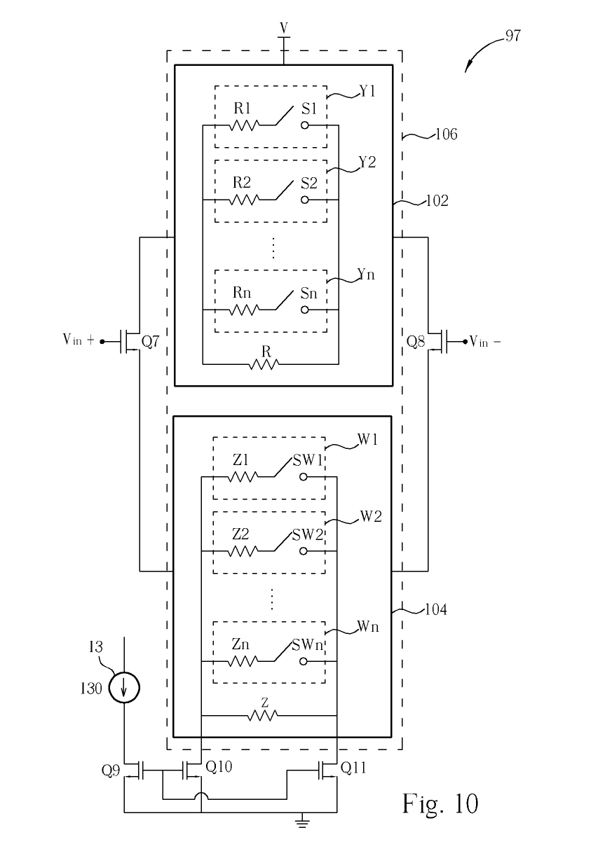

Please refer to FIG. 10 and FIG. 9. FIG. 10 is a diagram of the input buffer 97 shown in FIG. 9. An operation voltage of the input buffer is a supply voltage V. The input buffer 97 comprises a gain compensation circuit 106 used to compensate a gain of the input buffer 97. The gain compensation circuit 106 comprises a gain circuit 102 and a load circuit 104. The gain circuit 102 comprises a plurality of gain units Y1-Yn coupled in parallel. Each gain unit comprises a resistor and a switch and they are represented by R1-Rn and S1-Sn respectively. The gain circuit 102 further comprises a resistor R coupled in parallel with the plurality of gain units Y1-Yn, so that a resistance of the gain compensation circuit 102 is not 0. The resistor R can also be adjustable resistor used for choosing a reference output power of the transmitter 90, and in this case the voltage gain control amplifier 92 is undesirable in choosing the reference output power of the transmitter 90.

Please refer to FIG. 10. The load circuit 104 is coupled to the temperature sensor 96 (not shown in FIG. 10) and the gain circuit 102, and is used to provide a load to the input buffer 97. The load circuit 104 comprises a plurality of load units W1-Wn coupled in parallel. Each load unit comprises a resistor and a switch and they are represented by Z1-Zn and SW1-SWn respectively. The load circuit 104 further comprises a resistor Z coupled in parallel with the plurality of the load units W1-Wn, so that a resistance of the gain circuit 102 is not 0. According to a temperature sensed by the temperature sensor 96, an equivalent resistance of the load circuit 104 can be changed with switching the plurality of switches SW1-SWn. Due to the input buffer 97 being proportional to a ratio of resistance of the load circuit 104 and resistance of the gain circuit 102 (Gain≈Z/R), by choosing the equivalent resistance of the gain compensation circuit 106 to change the gain, the gain of the input buffer 97 can be adjusted and compensated.

Please refer to FIG. 10. The input buffer 97 comprises a differential pair coupled between the load circuit 104 and the gain circuit 102. The differential pair comprises a seventh transistor Q7, a gate of the seventh transistor Q7 being coupled to a first input voltage Vin+; and a eighth transistor Q8, a gate of the eighth transistor Q8 being coupled to a second input voltage Vin−. A first end of the gain circuit 102 is coupled to a source of the seventh transistor Q7 and a second end of the gain circuit 102 is coupled to a source of the eighth transistor Q8. A first end of the load circuit 104 is coupled to a drain of the seventh transistor Q7 and a second end of the load circuit 104 is coupled to a drain of the eighth transistor Q8.

Please refer to FIG. 10. The input buffer 97 further comprises a third current source I3 used to provide a current I30 and three transistors Q9-Q11 used to provide current I30 with a current path. A source of the transistor Q9 is coupled to a output of the third current source I3; a gate of the transistor Q9 is coupled to a gate of the transistor Q10 and the gate of the transistor Q11; a drain of the transistor Q9 is coupled to a drain of the transistor Q10 and the drain of the transistor Q11 and then connect to ground. The source of the transistor Q10 is coupled to a first end of the load circuit 104 and the drain of the seventh transistor Q7; the source of the transistor Q11 is coupled to a second end of the load circuit 104 and the drain of the eighth transistor Q8.

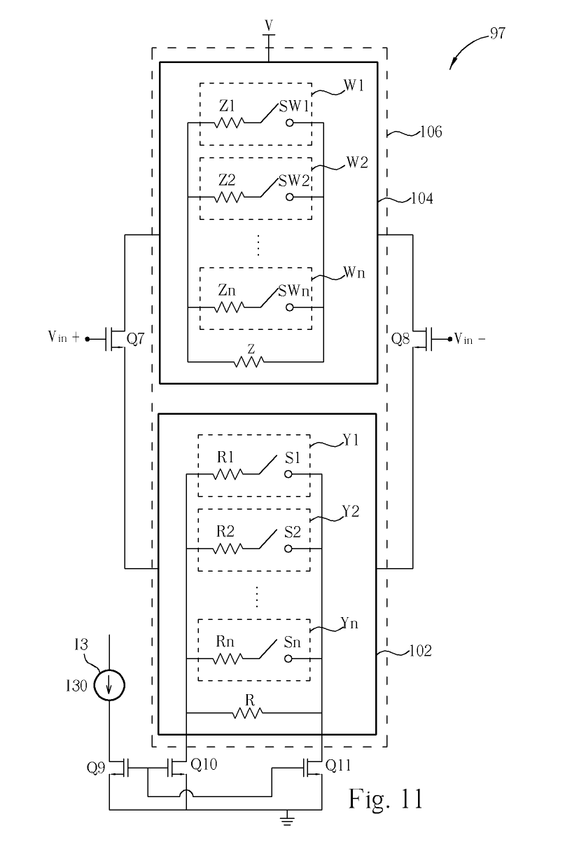

Please refer to FIG. 11 and FIG. 9. FIG. 11 is another diagram of the input buffer 97 shown in FIG. 9. An operation voltage of the input buffer is a supply voltage V. The input buffer 97 comprises a gain compensation circuit 106 used to compensate a gain of the input buffer 97. The gain compensation circuit 106 comprises a gain circuit 102 and a load circuit 104. The load circuit 104 comprises a plurality of load units W1-Wn coupled in parallel. Each load unit comprises a resistor and a switch and they are represented by Z1-Zn and SW1-SWn respectively. The load compensation circuit 104 further comprises a resistor Z coupled in parallel with the plurality of load units W1-Wn, so that a resistance of the load compensation circuit 104 is not 0. The resistor Z can also be an adjustable resistor used for choosing a reference output power of the transmitter 90, and in this case the voltage gain control amplifier 92 is undesirable in choosing the reference output power of the transmitter 90.

Please refer to FIG. 11. The gain circuit 102 is coupled to the temperature sensor 96 (not captioned in FIG. 11) and the load circuit 104, used to provide a load to the input buffer 97. The gain circuit 102 comprises a plurality of gain units Y1-Yn coupled in parallel. Each gain unit comprises a resistor and a switch and they are represented by R1-Rn and S1-Sn respectively. The gain circuit 102 further comprises a resistor R coupled in parallel with the plurality of the gain units Y1-Yn, so that a resistance of the gain circuit 102 is not 0. According to a temperature sensed by the temperature sensor 96, an equivalent resistance of the gain circuit 102 can be changed with switching the plurality of switches S1-Sn. Due to the input buffer 97 being proportional to a ratio of resistance of the load circuit 104 and resistance of the gain circuit 102 (Gain≈Z/R), by choosing the equivalent resistance of the gain compensation circuit 106 to change the gain, the gain of the input buffer 97 can be adjusted and compensated.

Please refer to FIG. 11. The input buffer 97 comprises another differential pair coupled between the load circuit 104 and the gain circuit 102. The differential pair comprises a seventh transistor Q7, a gate of the seventh transistor Q7 coupled to a first input voltage Vin+; and a eighth transistor Q8, a gate of the eighth transistor Q8 coupled to a second input voltage Vin−. A first end of the load circuit 104 is coupled to a source of the seventh transistor Q7; a second end of the load circuit 104 is coupled to a source of the eighth transistor Q8. A first end of the gain circuit 102 is coupled to a drain of the seventh transistor Q7; a second end of the I gain circuit 102 is coupled to a drain of the eighth transistor Q8.

Please refer to FIG. 11. The input buffer 97 further comprises a third current source I3 used to provide a current I30 and three transistors Q9-Q11 used to provide current I30 with a current path. A source of the transistor Q9 is coupled to an output of the third current source I3; a gate of the transistor Q9 is coupled to a gate of the transistor Q10 and a gate of the transistor Q11; a drain of the transistor Q9 is coupled to a drain of the transistor Q10 and the drain of the transistor Q11 and then connect to ground. The source of the transistor Q10 is coupled to a first end of the gain circuit 102 and the drain of the seventh transistor Q7; the source of the transistor Q11 is coupled to a second end of the gain circuit 102 and the drain of the eighth transistor Q8.

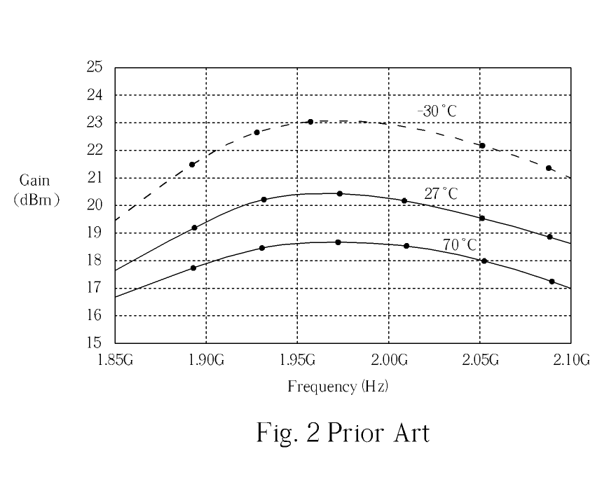

Please refer to FIG. 2, FIG. 4, FIG. 5, and FIG. 7. If a current temperature T is larger than 70 degrees, bits B0-B5 output is <111111>, meaning VTC>V0>V1>V2>V3>V4>V5. In this case the gain of the mixer 61 is low (as shown in FIG. 2, the lower curve representing the relationship of gain and frequency at 70 degrees Celsius). Due to the gain of the mixer 61 being proportional to a ratio of resistance of the load circuit 72 and resistance of the compensation circuit 76 (Gain≈Z/R), and the resistance of the load circuit 72 is constant, the gain of the mixer 61 can be raised by lowering the resistance of the gain compensation circuit 76. This can be achieved by opening more of the switches S1-Sn to have more of the resistors R1-Rn coupled in parallel, in order to increase the gain. On the other hand, if the current temperature T is smaller than negative 30 degrees, bits B0-B5 output is <000000>, meaning VTC<V5<V4<V3<V2<V1<V0. In this case the gain of the mixer 61 is high (as shown in FIG. 2, the upper curve representing the relationship of gain and frequency at negative 30 degrees). Increasing the resistance of the gain compensation circuit 76 can lower the gain of the mixer 61. This can be achieved by closing more of the switches S1-Sn to have fewer of the resistors R1-Rn coupled in parallel, in order to decrease the gain.

Please refer to FIG. 2, FIG. 4, FIG. 5, and FIG. 10. If a current temperature T is larger than 70 degrees, bits B0-B5 output is <111111>, meaning VTC>V0>V1>V2>V3>V4>V5. In this case the gain of the input buffer 97 is low (as shown in FIG. 2, the lower curve representing the relationship of gain and frequency at 70 degrees Celsius). Due to the gain of the input buffer 97 being proportional to a ratio of resistance of the load circuit 104 and resistance of the gain circuit 102 (Gain≈Z/R), and assuming the resistance of the gain circuit 102 is constant, the gain of the input buffer 97 can be raised by increasing the resistance of the load circuit 104. This can be achieved by closing more of the switches SW1-SWn to have fewer of the resistors Z1-Zn coupled in parallel, in order to increase the gain. On the other hand, if the current temperature T is smaller than negative 30 degrees, bits B0-B5 output is <000000>, meaning VTC<V5<V4<V3<V2<V1<V0. In this case the gain of the input buffer 97 is high (as shown in FIG. 2, the upper curve representing the relationship of gain and frequency at negative 30 degrees). Decreasing the resistance of the load circuit 104 can lower the gain of the input buffer 97. This can be achieved by opening more of the switches SW1-SWn to have more of the resistors Z1-Zn coupled in parallel, in order to decrease the gain.

Please refer to FIG. 2, FIG. 4, FIG. 5, and FIG. 11. If a current temperature T is larger than 70 degrees, bits B0-B5 output is <111111>, meaning VTC>V0>V1>V2>V3>V4>V5. In this case the gain of the input buffer 97 is low (as shown in FIG. 2, the lower curve representing the relationship of gain and frequency at 70 degrees Celsius). Due to the gain of the input buffer 97 being proportional to a ratio of resistance of the load circuit 104 and resistance of the gain circuit 102 (Gain≈Z/R), and assuming the resistance of the load circuit 104 is constant, the gain of the input buffer 97 can be raised by decreasing the resistance of the gain circuit 102. This can be achieved by opening more of the switches S1-Sn to have more of the resistors R1-Rn coupled in parallel, in order to increase the gain. On the other hand, if the current temperature T is smaller than negative 30 degrees, bits B0-B5 output is <000000>, meaning VTC<V5<V4<V3<V2<V1<V0. In this case the gain of the input buffer 97 is high (as shown in FIG. 2, the upper curve representing the relationship of gain and frequency at negative 30 degrees). Increasing the resistance of the gain circuit 102 can lower the gain of the input buffer 97. This can be achieved by closing more of the switches S1-Sn to have fewer of the resistors R1-Rn coupled in parallel, in order to decrease the gain.

The above is only a description of the present invention, and does not limit the present invention. In the present invention, the temperature sensor is composed by a plurality of temperature sensitive resistors, but it can also use other components that provide similar functions. The gain compensation circuit and the load circuit use a plurality of resistors and switches coupled in parallel, and are not limited to these as well.

To conclude, the present invention provides a transmitter with temperature gain compensation and controls the opening or closing of the plurality of switches according to the temperature sensed by the temperature sensor to change the equivalent resistance of the gain compensation circuit or the load circuit. As temperature changes, the gain of the wireless signal transmitted by the transmitter will not change, which means a constant output power of the transmitter.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transmitter with temperature gain compensation comprising:
a temperature sensor;
a mixer comprising:
a mixing circuit for producing a mixing signal of a baseband signal and a local oscillation signal;
a gain compensation circuit coupled between the mixing circuit and the temperature sensor for compensating a gain of the mixer, the gain compensation circuit including a plurality of compensation units coupled in parallel which are driven on and off by a detected temperature sensed by the temperature sensor;
a power amplifier coupled to the mixer;
an antenna couple to the power amplifier; and
a matching circuit coupled between the power amplifier and the antenna.

2. The transmitter of claim 1 wherein each of the compensation unit comprises a resistor and a switch.

3. The transmitter of claim 1 wherein the mixing circuit comprises
a first transistor comprising a first gate for receiving a positive signal of a differential pair of the local oscillation signal, a first source and a first drain;
a second transistor comprising a second gate for receiving a negative signal of the differential pair of the local oscillation signal, a second source and a second drain coupled to the first drain;
a third transistor comprising a third gate coupled to the second gate and for receiving the negative signal of the differential pair of the local oscillation signal, a third source, and a third drain;
a fourth transistor comprising a fourth gate coupled to the first gate and for receiving the positive signal of the differential pair of the local oscillation signal, a fourth source, and a fourth drain coupled to the third drain;
a fifth transistor comprising a fifth gate for receiving a positive signal of a differential pair of the baseband signal, a fifth source coupled to the first drain and the second drain, and a fifth drain coupled to a first end of the plurality of compensation units; and
a sixth transistor comprising a sixth gate for receiving a negative signal of the differential pair of the baseband signal, a sixth source coupled to the third drain and the fourth drain, and a sixth drain coupled to a second end of the plurality of compensation units.

4. The transmitter of claim 3 wherein the first transistor, the second transistor, the third transistor, the fourth transistor, the fifth transistor and the sixth transistor are metal-oxide semiconductor (MOS) transistors.

5. The transmitter of claim 3 further comprising:
a load circuit; and
a local oscillation signal input circuit comprising a first local oscillation signal input coupled to the first and fourth gates of the mixing circuit for feeding the positive signal of the differential pair of the local oscillation signal; and
a second local oscillation signal input coupled to the second and third gates of the mixing circuit for feeding the negative signal of the differential pair of the local oscillation signal.

6. The transmitter of claim 5 wherein the load circuit comprises a first port coupled to the first source of the first transistor and the third source of the third transistor, and a second port coupled to the second source of the second transistor and the fourth source of the fourth transistor.

7. The transmitter of claim 1 further comprising a voltage gain control amplifier (VGA) coupled to the mixing circuit and the power amplifier for selecting reference output power of the transmitter.

8. The transmitter of claim 1 wherein the gain compensation circuit further comprises a resistor coupled to the plurality of compensation units coupled in parallel.

9. A transmitter with temperature gain compensation comprising:
a temperature sensor;
an input buffer comprising:
a gain compensation circuit comprising:
a load circuit coupled to the temperature sensor for providing a load for the input buffer, the load circuit comprising a plurality of load units coupled in parallel which are driven on and off selectively by a temperature sensed by the temperature sensor for compensating a gain of the gain compensation circuit; and
a gain circuit coupled to the temperature sensor and the load circuit for compensating a gain of the input buffer, the gain circuit comprising a plurality of gain units coupled in parallel which are driven on and off selectively by the temperature sensed by the temperature sensor for compensating the gain of the gain compensation circuit;
a mixer coupled to the input buffer for mixing a baseband signal output by the input buffer and a local oscillation signal for generating a mixing signal;
a power amplifier coupled to the mixer;
an antenna coupled to the power amplifier; and
a matching circuit coupled in between the power amplifier and the antenna.

10. The transmitter of claim 9 wherein the plurality of load units each comprise a resistor and a switch.

11. The transmitter of claim 9 wherein the plurality of gain units each comprise a resistor and a switch.

12. The transmitter of claim 9 wherein the mixer comprises:
a first transistor comprising a first gate for receiving a positive signal of a differential pair of the local oscillation signal, a first source and a first drain;
a second transistor comprising a second gate for receiving a negative signal of the differential pair of the local oscillation signal, a second source and a second drain coupled to the first drain;
a third transistor comprising a third gate coupled to the second gate and for receiving the negative signal of the differential pair of the local oscillation signal, a third source, and a third drain;
a fourth transistor comprising a fourth gate coupled to the first gate and for receiving the positive signal of the differential pair of the local oscillation signal, a fourth source, and a fourth drain coupled to the third drain;
a fifth transistor comprising a fifth gate for receiving a positive signal of a differential pair of the baseband signal, a fifth source coupled to the first drain and the second drain, and a fifth drain coupled to a first end of the plurality of compensation units; and
a sixth transistor comprising a sixth gate for receiving a negative signal of the differential pair of the baseband signal, a sixth source coupled to the third drain and the fourth drain, and a sixth drain coupled to a second end of the plurality of compensation units.

13. The transmitter of claim 12 wherein the first transistor, the second transistor, the third transistor, the fourth transistor, the fifth transistor and the sixth transistor are metal-oxide semiconductor (MOS) transistors.

14. The transmitter of claim 12 further comprising:
a local oscillation signal input circuit comprising a first local oscillation signal input coupled to the first and fourth gates of the mixer for feeding the positive signal of the differential pair of the local oscillation signal; and a second local oscillation signal input coupled to the second and third gates of the mixer for feeding the negative signal of the differential pair of the local oscillation signal.

15. The transmitter of claim 9 wherein the input buffer further comprises a differential pair coupled between the load circuit and the gain circuit.

16. The transmitter of claim 15 wherein the differential pair comprises:
a seventh transistor comprising a seventh gate coupled to a first input voltage, a seventh source, and a seventh drain; and
an eighth transistor comprising an eighth gate coupled to a second input voltage, an eighth source, and an eighth drain.

17. The transmitter of claim 9 further comprising a bandpass filter coupled between the input buffer and the mixer for filtering noise and allowing signals passing through a selected band of frequency.

18. The transmitter of claim 9 wherein the load circuit further comprises a resistor coupled to the plurality of load units in parallel.

19. The transmitter of claim 9 wherein the gain circuit further comprises a resistor coupled to the plurality of gain units in parallel.

20. The transmitter of claim 9 further comprising a voltage gain control amplifier coupled to the mixer and the power amplifier for selecting reference output power of the transmitter.
